(19) United States
(12) Patent Application Publication
(10) Pub. No.: US 2017/0297107 A1
(43) Pub. Date: Oct. 19, 2017

(54) ADDITIVE FABRICATION PROCESSING METHOD AND ADDITIVE FABRICATION PROCESSING APPARATUS FOR PERFORMING ADDITIVE FABRICATION BY MOVING A PROCESSING PART THAT IRRADIATES LASER WHILE SUPPLYING METAL POWDER

(71) Applicant: FANUC CORPORATION, Yamanashi (JP)

(72) Inventors: Masaki OKA, Yamanashi (JP); Takeshi MOCHIDA, Yamanashi (JP)

(21) Appl. No.: 15/480,663

(22) Filed: Apr. 6, 2017

(30) Foreign Application Priority Data
Apr. 14, 2016 (JP) 2016-080876

(51) Int. Cl. B22F 3/105; B33Y 10/00; B33Y 50/02; B33Y 30/00

(52) U.S. Cl. CPC B22F 3/1055; B33Y 50/02; B33Y 30/00; B33Y 10/00; B22F 2003/1057; B22F 2998/10

(57) ABSTRACT

The additive fabrication processing method includes: a setting step of setting a speed command value indicating the speed of a processing head, and a metal powder supply amount command value indicating a supply amount of the metal powder corresponding to the speed command value; an acquisition step of acquiring both a speed indicating the speed of the processing head at which actually moving and an actual distance indicating a distance actually between the processing head and a surface on which spraying metal powder; and a supply amount calculation step of calculating a metal powder supply amount by correcting the metal powder supply amount command value based on the speed and the actual distance, so that a program command route and a processed surface match.

This application is based on and claims the benefit of priority from Japanese Patent Application No. 2016-080876, filed on 14 Apr. 2016, the content of which is incorporated herein by reference.

### BACKGROUND OF THE INVENTION

### Field of the Invention

The present invention relates to additive fabrication that controls a supplied amount of metal powder.

### Related Art

Conventionally, a powder head method that spreads out metal powder and irradiates a beam to form a cured layer, a powder spray method that sprays metal powder simultaneously while irradiating a beam to form a cured layer, etc. have been known as technologies that additive fabrication processing of metal. As documents disclosing technology related to the powder spray method, there is Patent Documentand Patent Document 2, for example. Patent Document 1 describes technology related to laser processing that arranges powder of ceramic, metal or the like onto a base material surface, and repeats heating and sintering by laser. Patent Document 2 describes, for a method of producing a solid in which a plurality of sintered layers are integrally laminated, a technology that moves a location at which supplying powder material, while sintering this supplied powder material by heating with a high-density energy heat source.

Patent Document 1: Japanese Patent No. 2798281

Patent Document 2: Japanese Unexamined Patent Application, Publication No. 2006-200030

### SUMMARY OF THE INVENTION

Generally, a workpiece in which a processed surface matching (made parallel to) a program command route is made a high-precision workpiece. However, in lamination processing of the powder spray method that sprays metal powder along with irradiating a laser from a processing head to laminate molten layers, a processed surface in accordance with the program command route may not be obtained due to the speed at which moving the processing head and irregularities in the surface on which metal powder is sprayed.

FIG. 1 is a view schematically showing an example of a route of the processing head advancing so as to bend. In FIG. 1, the route of the processing head that advanced straight on route N1, then changed direction to bend to route N2 is shown by XY coordinates (plane). At the corner at which curving from route N1 to route N2, deceleration in speed of the processing head is performed. FIG. 2 is a view schematically showing an example in which the processed surface in accordance with the program command route could not be obtained due to variation in processing speed. As shown in FIG. 2, when the moving speed of the processing head decelerates at the corner, the metal powder supplied per unit area increases, and the molten layer thickens by this portion.

FIG. 3 is a view schematically showing an example of a route of the processing head advancing linearly. In FIG. 3, a linear route N3 is shown, and the processing head moves along the route N3 at a constant speed. FIG. 4 is a view schematically showing an example in which a processed surface in accordance with the program command route is not obtained due to irregularities in the surface on which spraying metal powder. As shown in FIG. 4, the processed surface obtained is concaved by the portion that the surface is concaved, and the processed surface obtained swelled where the surface swelled. Also in cases such that advance the linear route N3 at a constant speed in this way, a processed surface in accordance with the program command route is no longer obtained if there are irregularities in the surface on which spraying the metal powder.

With conventional technology such as that disclosed in Patent Document 1 or Patent Document 2, it has not been possible to sufficiently handle the situation in which a processed surface is not obtained in accordance with the above-mentioned program command route. For example, although Patent Document 2 describes making the feed rate of powder material smaller at locations on the outer layer side of the sought solid product, and making the feed rate of the powder material larger at locations on an inner layer side of the sought solid product, the variations in processing speed and irregularities in the surface have not been taken into consideration.

The present invention has an object of providing an additive fabrication processing method and additive fabrication processing apparatus that control the supply amount of metal powder sprayed along with performing laser irradiation so as to be able to obtain a high-precision additive fabrication product in accordance with a program command route.

According to a first aspect of the present invention, an additive fabrication processing method of performing additive fabrication by moving a processing part (for example, the processing head 10 described later) that irradiates a laser (for example, the laser 4 described later) while supply metal powder (for example, the metal powder 5 described later) includes the steps of: setting a speed command value (for example, the speed command value Fc described later)) that indicates a speed of the processing part, and a metal powder supply amount command value (for example, the metal powder supply amount command value Mc described later) that indicates a supply amount of the metal powder corresponding to the speed command value; acquiring actual speed information (for example, the speed F described later) that reflects the speed of the processing part at which actually moving, or actual distance information (for example, the actual distance G described later) that indicates a distance actually between the processing part and a surface on which spraying the metal powder, or both the actual speed information and the actual distance information; and calculating a metal powder supply amount (for example, the metal powder supply amount Mout described later) by correcting the metal powder supply amount command value (Mc) based on at least one among the actual speed information and the actual distance information, so that a program command route and a processed surface match.

According to a second aspect of the present invention, in the additive fabrication processing method as described in the first aspect, a supply amount minimum value (for example, the minimum clamp value Mmin described later) may be set in advance for the metal powder supply amount, and the supply amount minimum value may be set as the metal powder supply amount in a case of the metal powder supply amount calculated based on the actual speed information falling below the supply amount minimum value.

According to a third aspect of the present invention, the additive fabrication processing method as described in the first or second aspect may further include a step of calculating a metal powder adjustment amount (for example, the metal powder adjustment amount A described later) in accordance with a difference between the actual distance information acquired in the step of acquiring and distance information (for example, the assumed distance Gc described later) set in advance, in which the metal powder supply amount may be calculated in the step of calculating the metal powder supply amount using the metal powder adjustment amount.

According to a fourth aspect of the present invention, in the additive fabrication processing method as described in the third aspect, an adjustment amount minimum value (for example, the minimum clamp value Amin described later)) and an adjustment amount maximum value (for example, the maximum clamp value Amax described later) may be set in advance for the metal powder adjustment amount, the adjustment amount minimum value may be set as the metal powder adjustment amount in a case of the metal powder adjustment amount falling below the adjustment amount minimum value, and the adjustment amount maximum value may be set as the metal powder adjustment amount in a case of the metal powder adjustment amount exceeding the adjustment amount maximum value (Amax).

According to a fifth aspect of the present invention, the additive fabrication processing method as described in any one of the first to fourth aspects may further include a step of calculating a laser output value (for example, the laser output value Pout described later) by correcting the laser output command value (for example, the laser output command value Pc described later) set in advance in accordance with the metal powder supply amount calculated in the step of calculating the metal powder supply amount.

According to a sixth aspect of the present invention, the additive fabrication processing method as described in the fifth aspect may further include a step of calculating a laser output adjustment amount (for example, the laser output adjustment amount B described later) in accordance with a difference between the metal powder supply amount calculated in the step of calculating the metal powder supply amount and the metal powder supply amount command value, in which the laser output value may be calculated in the step of calculating the laser output using the laser output adjustment amount.

According to a seventh aspect of the present invention, in the additive fabrication processing method as described in the sixth aspect, an output adjustment amount minimum value (for example, the minimum clamp value Bmin described later) and an output adjustment amount maximum value (for example, the maximum clamp value Bmax described later) may be set in advance for the laser output adjustment amount, the output adjustment amount minimum value may be set as the laser output adjustment amount in a case of the laser output adjustment amount falling below the output adjustment amount minimum value, and the output adjustment amount maximum value may be set as the laser output adjustment amount in a case of the laser output adjustment amount exceeding the output adjustment amount maximum value.

According to an eighth aspect of the present invention, an additive fabrication processing apparatus (for example, the additive fabrication processing apparatus described later) includes: a processing part (for example, the processing head 10 described later) which irradiates a laser (for example, the laser 4 described later) while supplying metal powder (for example, the metal powder 5 described later); and a control device (for example, the control device 20 described later) which sets a speed command value (for example, the speed command value Fc described later) that indicates a speed of the processing part, and a metal powder supply amount command value (for example, the metal powder supply amount command value Mc described later) that indicates a supply amount of the metal powder corresponding to the speed command value, in which the control device acquires actual speed information (for example, the speed F described later) that reflects a speed of the processing part at which actually moving, actual distance information (for example, the actual distance G described later) that indicates a distance actually between the processing part and a surface on which spraying the metal powder, or both the actual speed information and the actual distance information, and calculates a metal powder supply amount (for example, metal powder supply amount Mout described later) by correcting the metal powder supply amount command value based on at least one among the actual speed information and the actual distance information, so that a program command route and a processed surface match.

According to the additive fabrication processing method and additive fabrication processing apparatus of the present invention, it is possible for a program command route and processed surface to match, thereby obtaining a high-precision additive fabrication product.

### BRIEF DESCRIPTION OF THE DRAWINGS

FIG. 1 is a view schematically showing an example of the route of a processing head advancing so as to bend;

FIG. 2 is a view schematically showing an example in which a processed surface does not match with a program command path due to variations in processing speed;

FIG. 3 is a view schematically showing an example of the route of a processing head advancing linearly;

FIG. 4 is a view schematically showing an example in which the processed surface does not match the program command route due to irregularities in the surface on which spraying metal powder;

FIG. 5 is a view schematically showing a processing head of a additive fabrication processing apparatus according to an embodiment of the present invention;

FIG. 6 is a block diagram schematically showing an electrical connection relationship of the additive fabrication processing apparatus;

FIG. 7 is a graph showing the relationship of a standard metal powder supply amount relative to the speed of the processing head;

FIG. 8 is a graph showing the relationship of the metal powder adjustment amount relative to a difference between an ideal distance from the processing head until the surface on which spraying metal powder, and the distance during processing;

FIG. 9 is a flowchart showing the flow of processing to set the metal powder supply amount;

FIG. 10 is a graph showing the relationship of a laser output adjustment amount relative to a difference between a metal powder supply amount command value and the metal powder supply amount; and

FIG. 11 is a flowchart showing the flow of processing to set a laser output value.

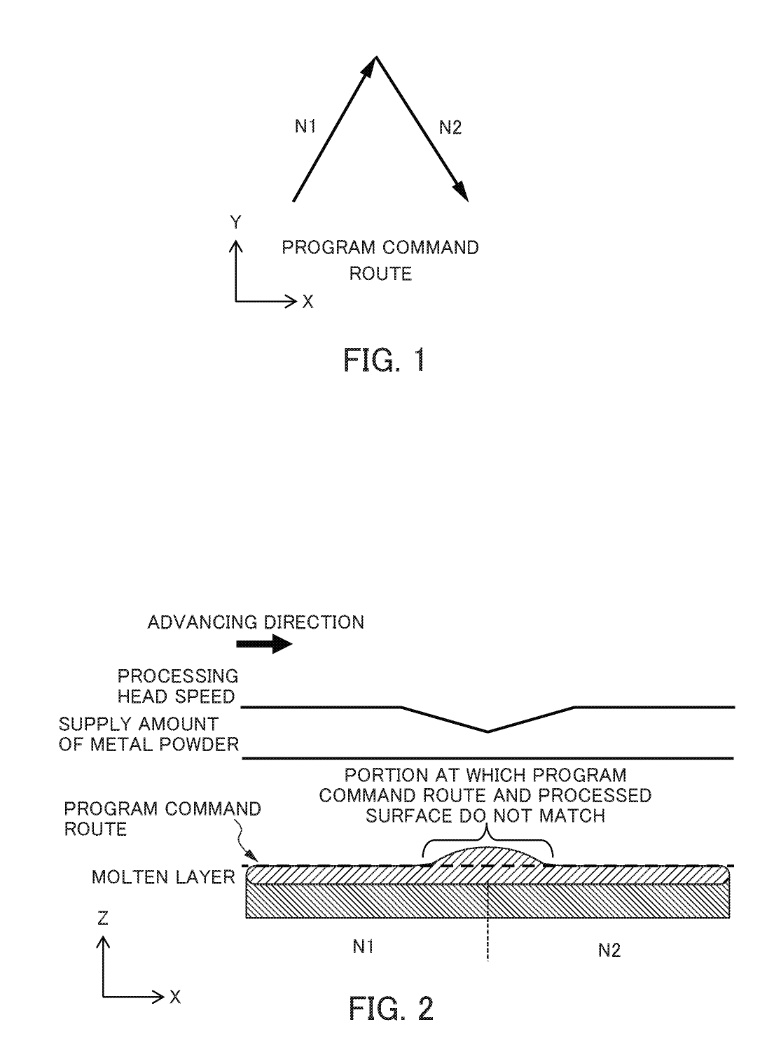

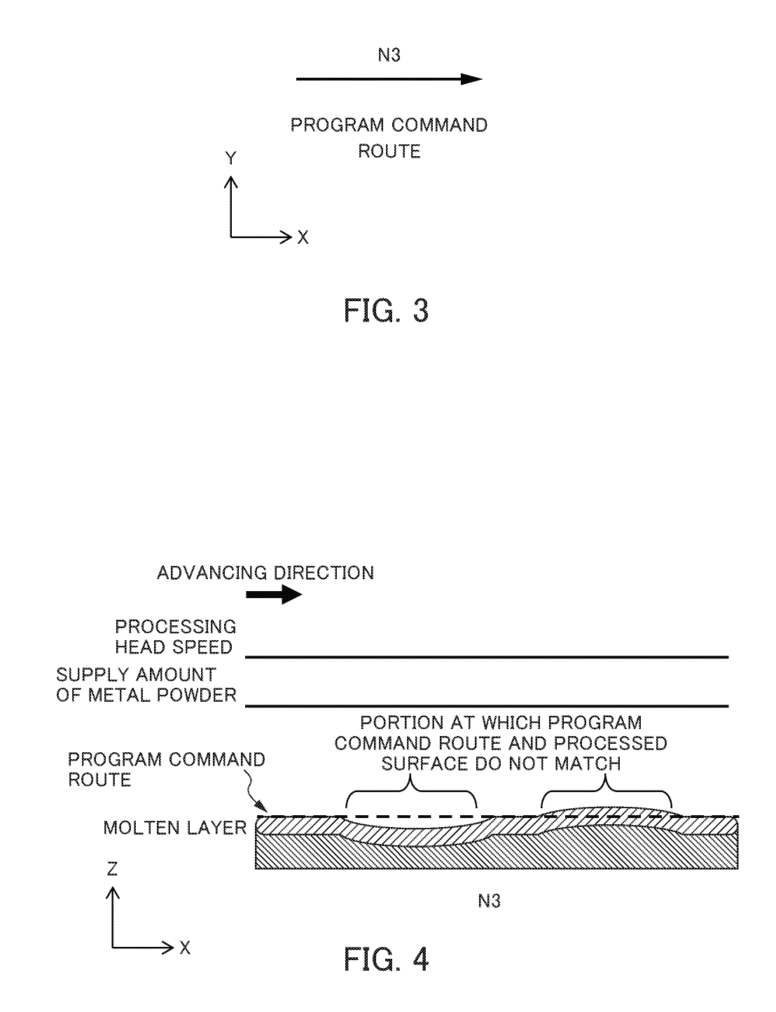

### DETAILED DESCRIPTION OF THE INVENTION

Hereinafter, a preferred embodiment of the present invention will be explained while referencing the drawings.

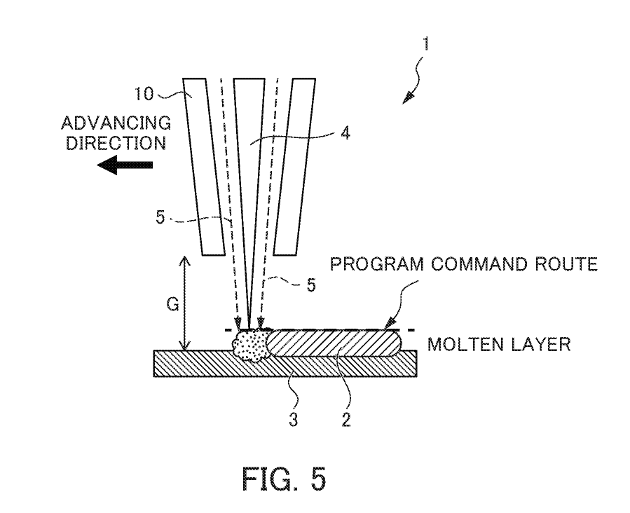

FIG. 5 is a view schematically showing a processing head 10 of an additive fabrication processing apparatus 1 according to an embodiment of the present invention. The additive fabrication processing apparatus 1 of the present embodiment is used in additive fabrication processing that forms a cured layer by way of a processing head 10 of powder spray type which sprays metal powder 5 simultaneously with the irradiation of a laser 4. The processing head 10 of the present embodiment is configured to enable adjustment of the supply amount of the metal powder 5, and the supply amount of the metal powder 5 sprayed during laser irradiation is adjusted according to the control of a control device 20 described later.

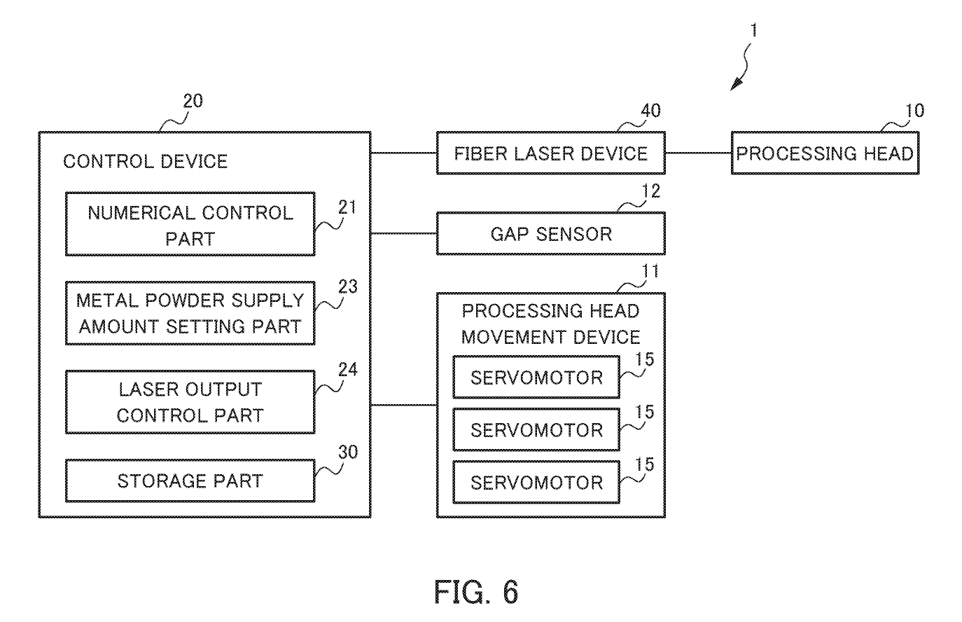

FIG. 6 is a block diagram schematically showing the electrical connection relationship of the additive fabrication processing apparatus 1. As shown in FIG. 6, the additive fabrication processing apparatus 1 includes the aforementioned processing head 10, a fiber laser device 40 to which the processing head 10 is connected, a processing head movement device 11 that causes the processing head 10 to move, a gap sensor 12, and a control device 20 for performing various controls on the additive fabrication processing apparatus 1.

The fiber laser device 40 is a fiber laser oscillator for outputting the laser 4, and is connected to the processing head 10. The fiber laser device 40 is electrically connected to the control device 20 described later, and is controlled by this control device 20.

The processing head movement device 11 is an arm-type robot having a plurality of servomotors 15, and the processing head 10 is mounted to a leading end thereof. The plurality of the servomotors 15 is connected to the control device 20 described later via a servo amplifier (not illustrated). The plurality of servomotors 15 corresponds to an X axis as a movement axis in the left/right direction, a Y axis as a movement axis in the forward/backward direction, and a Z axis as a movement axis in the vertical direction of the processing head 10, respectively, and enables the processing head 10 to be moved three-dimensionally. It should be noted that the processing head movement device 11 is not limited to an arm-type robot, and that an appropriate means for transporting the processing head 10 can be used. It should be noted that, although three of the servomotors 15 are illustrated in FIG. 6, the number or arrangement of the servomotors 15 is not to be limited thereto, and it is possible to appropriately modify according to the situation.

The gap sensor 12 is a distance detecting part that detects an actual distance G from the leading end of the processing head 10 until the surface on which spraying metal powder. The gap sensor 12 is installed to the leading end of the processing head 10, for example. It should be noted that, in the following explanation, in the case of simply referring to the distance between the processing head 10 and the surface on which spraying metal powder, it shall indicate the actual distance G from the leading end of the processing head 10 until the surface on which spraying metal powder.

The control device 20 is a CNC (numerical control) having a function of controlling laser irradiation and the movement of the processing head 10.

The control device 20 of the present embodiment includes: a numerical control part 21 that performs movement control for the processing head 10, a metal powder supply amount setting part 23 that controls the supply amount of the metal powder 5, a laser output control part 24 that controls the output of the laser 4, and a storage part 30 that stores various programs and data.

The numerical control part 21 functions as a numerical control that controls the respective servomotors 15 of different axis direction and arrangement of the processing head movement device 11 so that the processing head 10 moves based on the program command route set via an interface (not illustrated). The program command route is a route relative to the processing surface of lamination; however, it is a route of the processing head 10 set according to the processing target or processing objective, and the processing head 10 assumes a movement trajectory parallel to this program command route.

In addition, the numerical control part 21 controls the speed at which the processing head 10 moves by performing control on the servomotors 15 of each axis of the processing head movement device 11, based on a speed command value Fc set in the program.

The metal powder supply amount setting part 23 sets a metal powder supply amount Mout based on the speed of the processing head 10 and the actual distance G from the processing head 10 until the surface on which spraying the metal powder. The method of setting the metal powder supply amount Mout will be explained.

In the present embodiment, the metal powder supply amount Mout indicating the amount of the metal powder 5 actually supplied by the processing head 10 is set by way of calculating a reference metal powder supply amount M based on the actual movement speed of the processing head 10, and adding to this reference metal powder supply amount M a metal powder adjustment amount A that is set based the actual distance G between the processing head 10 and the surface on which spraying the metal powder. The metal powder supply amount Mout can be expressed by the following formula.

Mout=M+A (1)
Mout: metal powder supply amount (Mout>0)
M: reference metal powder supply amount
A: metal powder adjustment amount

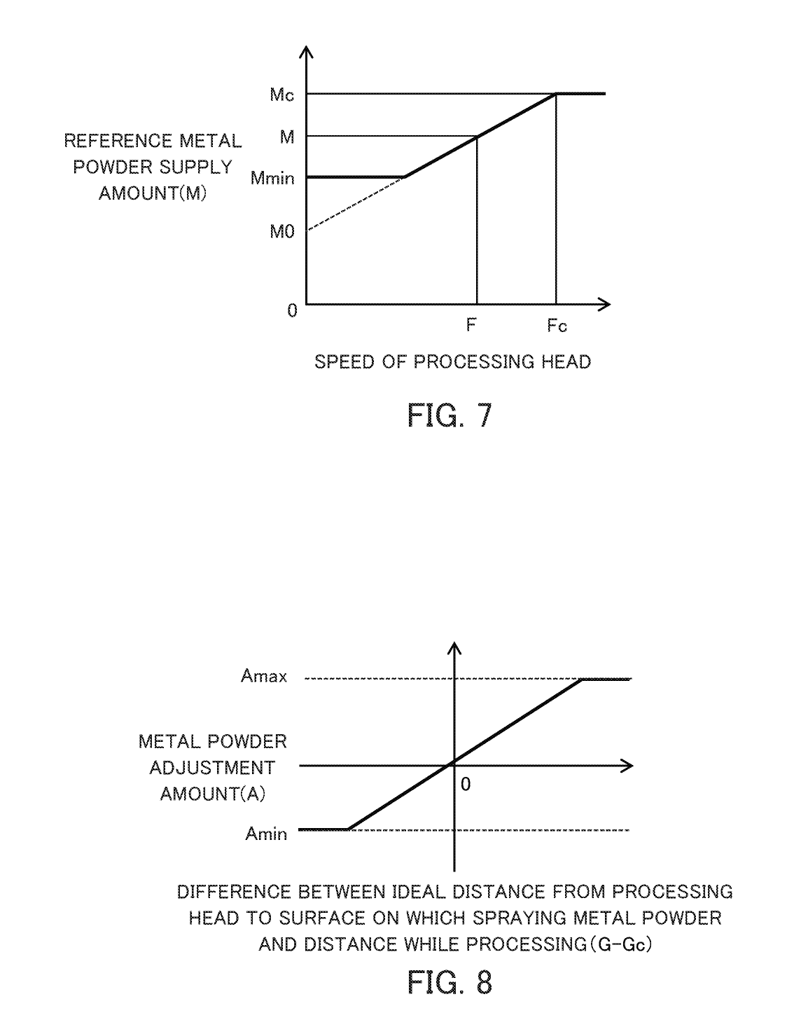

Setting of the reference metal powder supply amount M will be explained. FIG. 7 is a graph showing the relationship of the reference metal powder supply amount M relative to the speed of the processing head 10. The reference metal powder supply amount M is a value indicating the supply amount of the metal powder reflecting the actual speed prior to the metal powder adjustment amount described later being considered, and is calculated according to the following formula.

M=M0+(Mc−M0)×(F/Fc) (2)
Mc: metal powder supply amount command value corresponding to speed command value Fc
M0: metal powder supply amount in case of speed of processing head being 0
F: speed of processing head calculated from speed command value outputted on each axis
Fc: speed command value designated by program

The speed F is a value calculated as the actual speed of the leading end of the processing head 10 that irradiates the laser 4 along with discharging the metal powder 5 (actual speed information), from the speed command value outputted by the numerical control part 21 on each axis. As shown in Formula (2), the reference metal powder supply amount M is a value in which the speed F of the processing head 10 is reflected in the value of the speed command value Fc, and is calculated as a value in accordance with the actual speed F. As shown in FIG. 7, the metal powder supply amount command value Mc is a value set to correspond to the speed command value Fc. The speed F of the processing head 10 is the speed set based on the output numerical values of each servomotor (not illustrated) of the processing head movement device 11, for example, output values for the X axis, Y axis and Z axis, and is a value indicating the actual movement speed of the processing head 10.

In the present embodiment, M0 indicating the supply amount of metal powder in the case of the speed of the processing head 10 being 0 is set in advance as an intercept, and a minimum clamp value Mmin is set. The minimum clamp value Mmin is set to be greater than M0. In the case of the reference metal powder supply amount M being no more than the minimum clamp value Mmin, the minimum clamp value Mmin is set as the reference metal powder supply amount M.

The metal powder adjustment amount A will be explained. FIG. 8 is a graph showing the relationship of the metal powder adjustment amount A relative to a difference between an ideal assumed distance Gc from the processing head 10 until the surface on which spraying metal powder and the actual distance G during processing. The metal powder adjustment amount A is calculated according to the following formula.

A=Aadj×(G−Gc) (3)
Aadj: slope for determining metal powder adjustment amount A according to difference between actual distance G and assumed distance Gc
G: actual distance between processing head and surface on which spraying metal powder
Gc: assumed distance between processing head and surface on which spraying metal powder

As shown in Formula (3), the metal powder adjustment amount A is set as a value according to the actual distance G, in which the actual distance G in practice from the processing head 10 until the surface of the molten layer 2 is reflected based on a predetermined slope Aadj. The actual distance G is the distance between the processing head and surface on which spraying metal powder actually detected by the gap sensor 12. The assumed distance Gc is a distance set as an ideal distance between the processing head and the surface on which spraying metal powder, and is a value set in advance according to the program.

Aadj is the slope for determining the metal powder adjustment amount A according to the difference between the actual distance G and the assumed distance Gc, and is set in advance based on the relationship of the metal powder supply amount and the distance between the processing head 10 and the surface on which spraying metal powder. The metal powder adjustment amount A corresponding to the difference between the actual distance G and the assumed distance Gc is calculated using Formula (3).

As shown in FIG. 8, a minimum clamp value A min and a maximum clamp amount A max are each set for the metal powder adjustment amount A. In the case of the calculated metal powder adjustment amount A falling below the minimum clamp value Amin, this minimum clamp value Amin is set as the metal powder adjustment amount A. In the case of the calculated metal powder adjustment amount A exceeding the maximum clamp value Amax, this maximum clamp value Amax is set as the metal powder adjustment amount A.

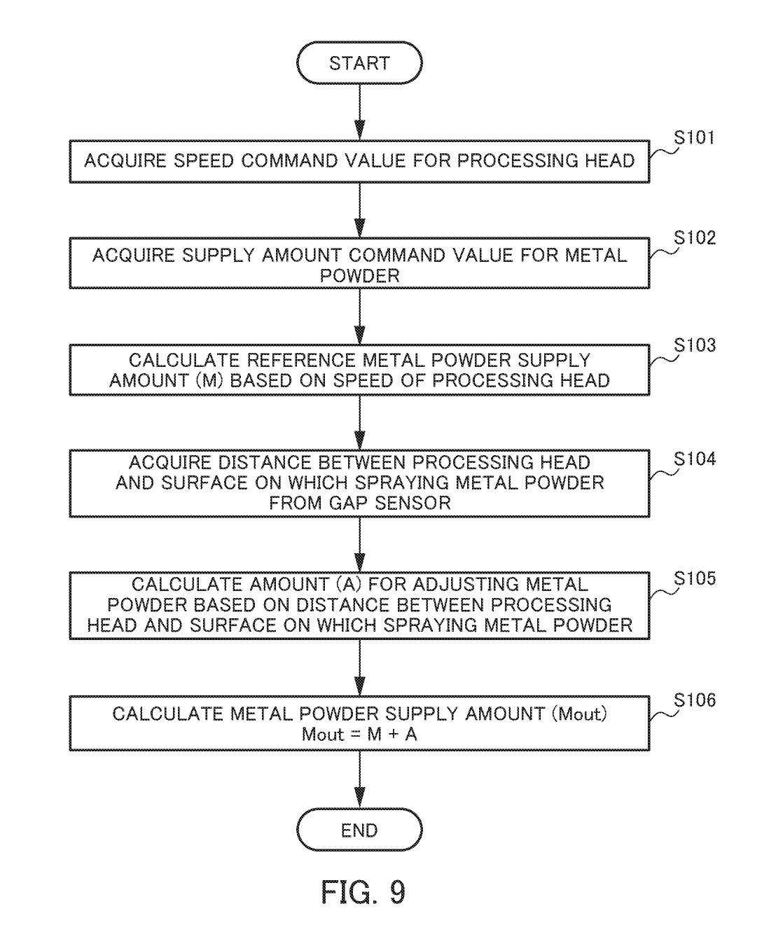

FIG. 9 is a flowchart showing the flow of processing to set the metal powder supply amount Mout. As shown in FIG. 9, when the processing to set the metal powder supply amount Mout is started, the metal powder supply amount setting part 23 of the control device 20 acquires the speed command value Fc of the processing head 10 set by the program (Step S101). Next, the metal powder supply amount command value Mc corresponding to the acquired speed command value Fc is acquired (Step S102).

The metal powder supply amount setting part 23 acquires the speed F of the processing head 10 based on the speed command value outputted by the numerical control part 21 to the servomotor 15 of each axis. This speed F is actual speed information of the processing head 10 controlled by the actual servomotor 15, and deceleration and acceleration in speed is also reflected in the case of the program command route curving, etc. Then, the reference metal powder supply amount M is calculated based on the speed F as the actual speed information and Formula (2) (Step S103).

Next, the actual distance G between the processing head 10 and the surface on which spraying the metal powder is acquired based on the detection value of the gap sensor 12 (Step S104), and the metal powder adjustment amount A is calculated based on Formula (3) (Step S105). Then, the metal powder supply amount Mout is calculated based on the reference metal powder supply amount M calculated in Step S103, and the metal powder adjustment amount A calculated in Step S105 (Step S106).

By way of the above processing, the metal powder supply amount Mout is calculated as a value in which the actual moving speed of the processing head 10 is reflected and the irregularities of the surface of the workpiece 3 that is the processing target are reflected, and this metal powder supply amount Mout is supplied from the processing head 10 in practice by the processing operation.

Next, the laser output control part 24 performing adjustment of the laser output based on the metal powder supply amount Mout will be explained. The laser output control part 24 sets the optimum laser output in accordance with the amount of the metal powder 5 actually supplied.

In the present embodiment, the laser output value Pout actually outputted is set by way of the laser output command value Pc set in advance being adjusted by the laser output adjustment amount B reflecting the actual distance G in practice. The laser output value Pout can be represented by the following formula.

Pout=Pc+B (4)
Pout: laser output value
B: laser output adjustment amount

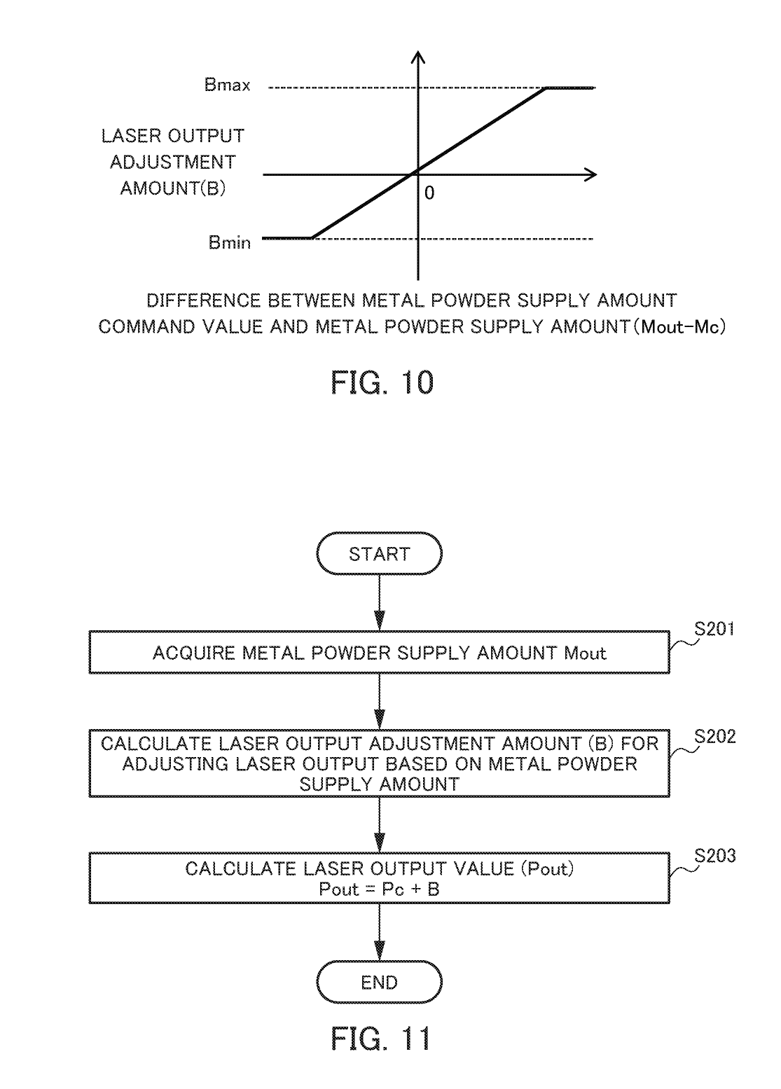

FIG. 10 is a graph showing the relationship of the laser output adjustment amount B relative to the difference between the metal powder supply amount command value Mc and the metal powder supply amount Mout. The laser output value Pout is calculated by the following formula. As shown in Formula (5), the laser output value Pout is calculated so that the metal powder supply amount actually supplied is reflected.

B=Badj×(Mout−Mc) (5)
Badj: slope for determining laser output adjustment amount B according to difference between metal powder supply amount Mout and metal powder supply amount command value Mc
Mout: metal powder supply amount actually supplied
Mc: metal powder supply amount command value

In addition, it is possible to express as in the following formula from Formula (4) and Formula (5).

Pout=Pc+(Badj×(Mout−Mc)) (6)

Badj is a slope for determining the laser output adjustment amount B according to the difference between the metal powder supply amount Mout and the metal powder supply amount command value Mc, and is set in advance based on the relationship between the metal powder supply amount and the laser output. The laser output adjustment amount B is set based on the difference between the metal powder supply amount Mout actually supplied and the metal powder supply amount command value Mc. Therefore, even in a case of the metal powder supply amount command value Mc being corrected to the metal powder supply amount Mout, the laser output value Pout according to this corrected metal powder supply amount Mout will be set.

As shown in FIG. 10, the minimum clamp value Bmin and maximum clamp value Bmax are each set for the laser output adjustment amount B. In the case of the calculated laser output adjustment amount B falling below the minimum clamp value Bmin, this minimum clamp value Bmin is set as the laser output adjustment amount B. In the case of the calculated laser output adjustment amount B exceeding the maximum clamp value Bmax, this maximum clamp value Bmax is set as the laser output adjustment amount B.

FIG. 11 is a flowchart showing the flow of processing to set the laser output value Pout. The flow of processing to set the laser output value Pout will be explained.

As shown in FIG. 11, the metal powder supply amount Mout first actually supplied is acquired in the processing to set the laser output value Pout (Step S201). Next, the laser output adjustment amount B is calculated based on Formula (5) from the metal powder supply amount command value MC and the metal powder supply amount Mout (Step S202). Then, the laser output value Pout is calculated based on the laser output adjustment amount B calculated in the processing of Step S202 and Formula (4) (Step S203).

According to the additive fabrication processing method of the embodiment explained above, the following such effects are exerted. Specifically, the additive fabrication processing method includes: a setting step of setting the speed command value Fc indicating the speed of the processing head 10 and the metal powder supply amount command value Mc indicating the supply amount of the metal powder 5 corresponding to the speed command value Fc (Steps S101 to S102); an acquisition step of acquiring both the speed F indicating the speed of the processing head 10 at which actually moving, and the actual distance G indicating the distance actually between the processing head 10 and the surface on which spraying the metal powder (Steps S103 to S105), and a supply amount calculation step of calculating the metal powder supply amount Mout by correcting the metal powder supply amount command value Mc based on the speed F and actual distance G, so that the program command route and processed surface match (Step S106).

It is thereby possible to obtain a high-precision additive fabrication product since the supply amount of the metal powder 5 being sprayed onto the workpiece 3 is adjusted according to the actual movement speed of the processing head 10 and the actual measured distance (actual distance G) between the processing head 10 and the surface on which spraying the metal powder, so that the program command route and processed surface match.

The minimum clamp value Mmin is set in advance as the metal powder supply amount Mout, and in the case of the metal powder supply amount Mout calculated based on the speed F of the processing head 10 at which actually moving falling below the minimum clamp value Mmin, the minimum clamp value Mmin is set to the metal powder supply amount Mout.

It is thereby possible to reliably prevent a situation in which the metal powder supply amount Mout is not supplying the required amount due to the speed F reflecting the actual movement speed becoming a low value, and possible to achieve both consistency between the program command route and the processed surface, and stabilization of the supply amount of the metal powder supply amount Mout.

In the supply amount calculation step including the metal powder adjustment amount calculation step (Step S105) of calculating the metal powder adjustment amount A according to the difference between the actual distance G acquired in the acquisition step and the ideal distance Gc set in advance, the metal powder supply amount Mout is calculated using the metal powder adjustment amount A.

It is thereby possible to have the actual condition reflected in the calculation of the metal powder supply amount Mout with good precision in simple processing, by using the difference between the actual distance G and the ideal distance Gc.

The minimum clamp value Amin and maximum clamp value Amax are set in advance for the metal powder adjustment amount A, and in the case of the metal powder adjustment amount A falling below the minimum clamp value Amin, the minimum clamp value Amin is set as the metal powder adjustment amount A, and in the case of the metal powder adjustment amount A exceeding the maximum clamp value Amax, the maximum clamp value Amax is set as the metal powder adjustment amount A.

It is thereby possible to reliably avoid a situation in which the metal powder supply amount Mout deviates from the appropriate range, without the metal powder adjustment amount A being set excessively, even in a case of the difference between the actual distance G and ideal distance Gc becoming too great or too small.

The additive fabrication processing method of the present embodiment includes a laser output calculation step (Steps S201 to S203) of calculating the laser output value Pout by correcting the laser output command value Pc set in advance, according to the metal powder supply amount Mout calculated in the supply amount calculation step.

It is thereby possible to greatly improve the precision of additive fabrication, since the laser output becomes a value in accordance with the metal powder supply amount Mout which was adjusted according to the actual conditions.

In the laser output calculation step including the laser adjustment amount calculation step (Step S202) of calculating the laser output adjustment amount B according to the difference between the metal powder supply amount Mout calculated in the supply amount calculation step and the metal powder supply amount command value Mc, the laser output value Pout is calculated using the laser output adjustment amount B.

By using the difference between the metal powder supply amount Mout and the metal powder supply amount command value Mc, it is thereby possible to have the metal powder supply amount Mout actually supplied reflected in the laser output with good precision by simple processing.

The minimum clamp value Bmin and maximum clamp value Bmax are set in advance for the laser output adjustment amount B, and in the case of the laser output adjustment amount B falling below the minimum clamp value Bmin, the minimum clamp value Bmin is set as the laser output adjustment amount B, and in the case of the laser output adjustment amount B exceeding the maximum clamp value Bmax, the maximum clamp value Bmax is set as the laser output adjustment amount B.

It is thereby possible to reliably prevent a situation in which the laser output excessively rises or excessively declines and the additive fabrication cannot be performed adequately, without the laser output adjustment amount B being set excessively, even in a case of the difference between the metal powder supply amount Mout and the metal powder supply amount command value Mc becoming too great or too small.

In addition, the additive fabrication processing apparatus 1 of the present embodiment includes the processing head 10 which irradiates the laser 4 while supplying the metal powder 5, and the control device 20 which sets the speed command value Fc indicating the speed of the processing head 10 and the metal powder supply amount command value Mc indicating the supply amount of the metal powder 5 corresponding to the speed command value Fc. Then, the control device 20 acquires the speed F indicating the speed of the processing head 10 at which actually moving and the actual distance G indicating the distance between the processing head 10 and the surface on which spraying the metal powder, and then calculates the metal powder supply amount Mout by correcting the metal powder supply amount command value Mc based on the speed F and actual distance G so that the program command route and the processed surface match. According to this configuration, since the supply amount of the metal powder 5 sprayed on the workpiece 3 is adjusted according to actual movement speed of the processing head 10 and the actual measured distance between the processing head 10 and the surface on which spraying the metal powder so that the program command route and the processed surface match, it is possible to obtain a high-precision additive fabrication product.

Although a preferred embodiment of the present invention has been explained above, the present invention is not to be limited to the aforementioned embodiment, and modifications are possible where appropriate.

The above-mentioned embodiment is a configuration that calculates the metal powder supply amount Mout by correcting the metal powder supply amount command value Mc based on both the speed F as the actual speed information and the actual distance G as the actual distance information; however, it is not limited to this configuration. For example, it is possible to calculate the metal powder supply amount Mout based on the speed F by omitting the processing to calculate the metal powder adjustment amount A, and calculate the metal powder supply amount Mout based on the actual distance G by omitting the processing to acquire the speed F and calculate the metal powder supply amount Mout. In other words, it is possible to establish a configuration that calculates the metal powder supply amount Mout based on either of actual speed information reflecting the speed of a processing part at which actually moving, or actual distance information indicating the distance actually between the processing part and the surface on which spraying metal powder. In addition, the above-mentioned embodiment calculates the laser output value Pout based on the metal powder supply amount Mout; however, it is also possible to omit the processing to adjust the laser output value based on the metal powder supply amount Mout.

In the above-mentioned embodiment, although the distance between the processing head 10 and the surface on which spraying metal powder is explained as the actual distance G from the leading end of the processing head 10 until the surface on which spraying the metal powder, so long as the actual distance information can be understood as a positional relationship between the processing head 10 and the surface on which spraying the metal powder, the reference positions for measuring the distance can be modified as appropriate according to the situation.

In the above-mentioned embodiment, the speed F is calculated based on the command from the numerical control part 21; however, it can also be configured to detect the speed of the processing head 10 by a different method.

In the above-mentioned embodiment, despite being a configuration that calculates the actual distance G by way of the gap sensor 12 serving as a distance detection part, the method of detecting the distance between the processing head 10 and the surface on which spraying metal powder can be modified as appropriate according to the situation.

The above-mentioned embodiment shows an example in which the control device 20 serves both purposes of a laser control device and a numerical control; however, it is not to be limited to this configuration. It is also possible to configure the laser control device and numerical control each as independent devices. In addition, it may be configured to control the processing head 10 by a different method from numerical control.

### EXPLANATION OF REFERENCE NUMERALS

1 additive fabrication processing apparatus

2 molten layer

4 laser

5 metal powder

10 processing head (processing part)

20 control device

A metal powder adjustment amount

Amax maximum clamp value (adjustment amount maximum value)

Amin minimum clamp value (adjustment amount minimum value)

B laser output adjustment amount

Bmax maximum clamp value (adjustment amount maximum value)

Bmin minimum clamp value (adjustment amount minimum value)

F speed (actual speed information)

G actual distance (actual distance information)

Fc speed command value

Mout metal powder supply amount

Mc metal powder supply amount command value

Mmin minimum clamp value (supply amount minimum value)

Pc laser output command value

Pout laser output value

What is claimed is:

1. An additive fabrication processing method of performing additive fabrication by moving a processing part that irradiates a laser while supplying metal powder, the method comprising the steps of:
setting a speed command value that indicates a speed of the processing part, and a metal powder supply amount command value that indicates a supply amount of the metal powder corresponding to the speed command value;
acquiring actual speed information that reflects the speed of the processing part at which actually moving, or actual distance information that indicates a distance actually between the processing part and a surface on which spraying the metal powder, or both the actual speed information and the actual distance information; and
calculating a metal powder supply amount by correcting the metal powder supply amount command value based on at least one among the actual speed information and the actual distance information, so that a program command route and a processed surface match.

2. The additive fabrication processing method according to claim 1, wherein a supply amount minimum value is set in advance for the metal powder supply amount, and
wherein the supply amount minimum value is set as the metal powder supply amount in a case of the metal powder supply amount calculated based on the actual speed information falling below the supply amount minimum value.

3. The additive fabrication processing method according to claim 1, further comprising a step of calculating a metal powder adjustment amount in accordance with a difference between the actual distance information acquired in the step of acquiring and distance information set in advance,
wherein the metal powder supply amount is calculated in the step of calculating the metal powder supply amount using the metal powder adjustment amount.

4. The additive fabrication processing method according to claim 3, wherein an adjustment amount minimum value and an adjustment amount maximum value are set in advance for the metal powder adjustment amount,
wherein the adjustment amount minimum value is set as the metal powder adjustment amount in a case of the metal powder adjustment amount falling below the adjustment amount minimum value, and
wherein the adjustment amount maximum value is set as the metal powder adjustment amount in a case of the metal powder adjustment amount exceeding the adjustment amount maximum value.

5. The additive fabrication processing method according to claim 1, further comprising a step of calculating a laser output value by correcting the laser output command value set in advance in accordance with the metal powder supply amount calculated in the step of calculating the metal powder supply amount.

6. The additive fabrication processing method according to claim 5, further comprising a step of calculating a laser output adjustment amount in accordance with a difference between the metal powder supply amount calculated in the step of calculating the metal powder supply amount and the metal powder supply amount command value,
wherein the laser output value is calculated in the step of calculating the laser output using the laser output adjustment amount.

7. The additive fabrication processing method according to claim 6,
wherein an output adjustment amount minimum value and an output adjustment amount maximum value are set in advance for the laser output adjustment amount,
wherein the output adjustment amount minimum value is set as the laser output adjustment amount in a case of the laser output adjustment amount falling below the output adjustment amount minimum value, and
wherein the output adjustment amount maximum value is set as the laser output adjustment amount in a case of the laser output adjustment amount exceeding the output adjustment amount maximum value.

8. An additive fabrication processing apparatus comprising:
a processing part which irradiates a laser while supplying metal powder; and
a control device which sets a speed command value that indicates a speed of the processing part, and a metal powder supply amount command value that indicates a supply amount of the metal powder corresponding to the speed command value,
wherein the control device acquires actual speed information that reflects a speed of the processing part at which actually moving, actual distance information that indicates a distance actually between the processing part and a surface on which spraying the metal powder, or both thereof, and calculates a metal powder supply amount by correcting the metal powder supply amount command value based on at least one among the actual speed information and the actual distance information, so that a program command route and a processed surface match.
